(19) United States
(12) Patent Application Publication
(10) Pub. No.: US 2026/0257802 A1
(43) Pub. Date: Sep. 3, 2026

(54) ASSEMBLY FOR AN AIRCRAFT COMPRISING A TURBOMACHINE, A PYLON AND A MOUNTING SYSTEM

(71) Applicant: Airbus Operations SAS, TOULOUSE (FR)

(72) Inventors: Naïm Boubaker BESSAH, PARIS (FR); Quentin Arnaud Thibaut COCHARD, PARIS (FR)

(21) Appl. No.: 19/546,623

(22) Filed: Feb. 23, 2026

(30) Foreign Application Priority Data
Feb. 28, 2025 (FR) FR2502088

(51) Int. Cl. B64D 27/40

(52) U.S. Cl. CPC B64D 27/402

(57) ABSTRACT

An assembly for an aircraft including a turbomachine, a pylon with forward end and a system for mounting the turbomachine to the pylon, the turbomachine extending along a longitudinal axis oriented in a direction of a flow generated by the turbomachine. The turbomachine includes, along the longitudinal axis, a forward casing, an intermediate casing, a turbine casing and an exhaust casing. The mounting system includes a forward mounting including a first suspension to suspend the turbomachine from the pylon fixed at the level of the forward casing and a rear mounting to mount the turbomachine to the pylon fixed at the level of the intermediate casing. The forward mounting includes a second suspension to suspend the turbomachine from the pylon fixed at the level of the intermediate casing. The first and second suspensions are fixed to the pylon in the same plane, perpendicular to the longitudinal axis.

### CROSS-REFERENCES TO RELATED APPLICATIONS

This application claims the benefit of French Patent Application Number FR2502088 filed on February 28, 2025, the entire disclosures of which are incorporated herein by way of reference.

### FIELD OF THE INVENTION

The invention relates to the field of mounting a turbomachine to an aircraft. In particular, the invention relates to an assembly for an aircraft comprising a turbomachine, a pylon and a system for connecting the turbomachine to the pylon.

### FIELD OF THE INVENTION

Existing systems for mounting a turbomachine on an aircraft pylon are described, for example, in documents WO2022/245363, WO2022/248791 and WO2023/198962.

A turbomachine generally comprises, in the direction of flow, an inlet section, a compressor section, a combustion section, a turbine section and an exhaust section. In operation, air enters through the inlet section and flows towards the compressor section, where one or more axial compressors progressively compress the air until it reaches the combustion section, where combustion gases are generated. The combustion gases then flow from the combustion section along a hot gas path defined in the turbine section and subsequently exit the turbomachine via the exhaust section. A turbomachine of this kind produces thrust enabling a vehicle, such as an aircraft, to be propelled. On an aircraft, the thrust thereby generated by the turbomachine produces thrust loads that are transmitted to a support, for example a pylon or a cradle, and likewise the vehicle applies equal and opposite reaction forces to the support. This loading induces pitching and yawing moments in the turbomachine. It is therefore necessary to reduce these pitching and yawing moments applied to the turbomachine so that it does not deform to such an extent that its operating performance is degraded. A conventional turbomachine suspension with a forward attachment on a forward casing and a rear attachment on a turbine casing or an exhaust casing does not make it possible to optimize the performance of the turbomachine and the aircraft cradle or pylon assembly.

Indeed, when the turbomachine produces thrust and is subjected to maneuver loads (aerodynamic forces acting on a nacelle or a propeller associated with the turbomachine), the turbomachine itself is subjected to forces. The bending (or “back-bone bending” in Anglo-Saxon terminology) of a turbomachine casing, induced by these forces, causes clearances to close or even wear to occur, degrading the performance of the turbomachine and thereby increasing fuel consumption and accelerating ageing of the turbomachine.

In the case of unshrouded turbomachines generally used on short-haul or medium-haul aircraft, the attachment of the turbomachine is particularly important, insofar as the turbomachine propeller has a large diameter and therefore generates significant axial moment loads. Furthermore, in order to achieve high performance, the turbomachine has a small high-pressure core which is therefore sensitive to all loads, such as gravitational loads, aircraft maneuvers and axial moment loads.

A conventional turbomachine suspension with a forward attachment on a forward casing and a rear attachment on a turbine casing or an exhaust casing does not make it possible to optimize the performance of the turbomachine and the aircraft cradle or pylon assembly.

Another known solution, disclosed in document WO2022/245363, is to position a rear suspension on the casing upstream of a high-pressure core (cantilevered high-pressure core solution). The bending moments induced by aerodynamic loads upstream of the turbomachine, and by thrust, then no longer pass through the high-pressure core. Moreover, this solution may create large relative displacements between the pylon and the turbomachine at the level of the high-pressure core, which is not supported by suspensions, in particular when the turbomachine is subjected to acceleration factors under gravitational acceleration and aircraft maneuvers, resulting in significant clearance consumption and turbomachine-to-pylon displacements. Furthermore, since the two suspension planes are close to one another, it is difficult to achieve a good compromise in stiffness between the pylon and the forward casing, which likewise leads to significant clearance consumption between the turbomachine and the pylon under axial moment loads.

Moreover, quasi-isostatic solutions have been envisaged in order to mitigate these problems, but either the volume of the interface and of the front part of the pylon required to support the turbomachine at the forward end and transmit the loads has the drawback of degrading the aerodynamics and complicating integration, or the propeller is arranged in cantilevered fashion, which complicates the turbomachine-side sizing (mass impact).

### SUMMARY OF THE INVENTION

An object of the invention is to provide an assembly for an aircraft comprising a turbomachine, a pylon and a system for mounting the turbomachine to the pylon that does not have the drawbacks of the prior art.

To this end, the invention provides an assembly for an aircraft comprising a turbomachine, a pylon having a forward end and a mounting system for mounting the turbomachine to the pylon, the turbomachine extending along a longitudinal axis oriented along an X-axis oriented in a direction of a flow generated by the turbomachine, of an orthonormal frame of reference comprising a Z-axis oriented towards the pylon, the turbomachine comprising, along the longitudinal axis, a forward casing, an intermediate casing and a rear casing, the mounting system comprising forward mounting means including first suspension means for suspending the turbomachine from the pylon fixed at the level of the forward casing of the turbomachine and rear mounting means for mounting the turbomachine to the pylon fixed at the level of the intermediate casing of the turbomachine, wherein the forward mounting means comprise second suspension means for suspending the turbomachine from the pylon fixed at the level of the intermediate casing, the first and second suspension means being fixed to the pylon in the same plane perpendicular to the longitudinal axis.

Advantageously, but optionally, the assembly according to the invention has at least one of the following technical features:

the plane perpendicular to the longitudinal axis is a plane passing through the intermediate casing;

the first and second suspension means are fixed to the pylon at the forward end of the pylon;

the first suspension means comprise a first forward link rod and a second forward link rod;

the first and second forward link rods each comprise a first end and a second end, each of the first ends and second ends comprising a spherical joint;

the first and second forward link rods are arranged in a “V” configuration, a vertex of the “V” being oriented forward;

the second suspension means comprise a first and a second rear link rod extending in a YZ plane perpendicular to the longitudinal axis;

the rear link rods are parallel to the Z-axis;

the rear link rods are inclined with respect to the Z-axis;

the rear link rods are provided with spherical joints at both ends;

the rear link rods are provided with spherical joints at both ends; - the rear mounting means comprise two load-take-up link rods arranged in a "V" configuration, a vertex of the "V" being oriented rearward and fixed to the pylon;

the mounting system comprises a flexible connection arranged between a rear casing, formed by the turbine casing and/or the exhaust casing, and the pylon and extending in a YZ plane perpendicular to the longitudinal axis; and

the forward end of the pylon is aligned with the intermediate casing.

The invention also provides an aircraft comprising an assembly having at least one of the preceding technical features.

### BRIEF DESCRIPTION OF THE FIGURES

Other features and advantages of the invention will become apparent from reading the following description of an embodiment of the invention. In the accompanying drawings:

FIG. 1 is a three-dimensional view of an assembly for an aircraft according to the invention, comprising a turbomachine, a pylon and a system for connecting the turbomachine to the pylon; and

FIG. 2 is a schematic top view of the assembly in FIG. 1.

For the sake of clarity, identical or similar elements are designated by identical reference signs throughout the figures.

### DETAILED DESCRIPTION OF THE PREFERRED EMBODIMENTS

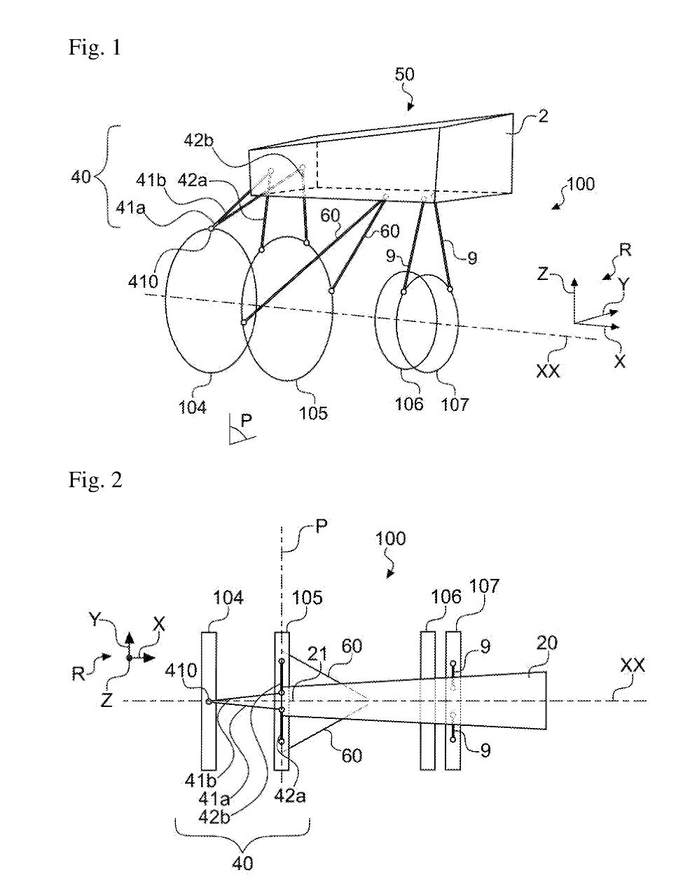

With reference to FIGS. 1 and 2, an embodiment of an assembly for an aircraft according to the invention will now be described, comprising a turbomachine 100, a pylon 20 and a mounting system 50 for mounting the turbomachine 100.

In this case, the turbomachine 100 further comprises a forward casing 104, an intermediate casing 105, a turbine casing 106 and an exhaust casing 107. It should be noted that as a general rule the forward casing 104 is also referred to as a “Propeller Frame” in Anglo-Saxon terminology and surrounds a propeller. The intermediate casing 105 is also referred to as a “Mid Frame” in Anglo-Saxon terminology. Moreover, the turbine casing 106 (also referred to as a “Turbine Vane Frame” in Anglo-Saxon terminology) is generally equipped with arms forming guide vanes, and the exhaust casing 107 (also referred to as a “Turbine Rear Frame” in Anglo-Saxon terminology) is the final casing of the turbomachine 1. Furthermore, the turbomachine 100 comprises, in particular, a preferably unshrouded propeller, a compressor, a combustion chamber and a turbine. It should be noted that the pylon 20 comprises a forward end 21 which, once the turbomachine 100 is mounted, is located in line with the intermediate casing 105. The turbomachine 100 extends along a longitudinal axis XX oriented along an X-axis, oriented in the direction of the flow generated by the turbomachine, of an orthonormal reference frame R comprising a Z-axis oriented towards the pylon and a Y-axis. Depending on the type of mounting of the turbomachine 100 on the aircraft, the Z-axis is vertical if the mounting is under a wing or the Z-axis is horizontal if the mounting is at the rear of a fuselage of the aircraft.

The mounting system 50 comprises forward mounting means 40 in two parts: a first part formed by first suspension means 41 positioned between the forward end 21 of the pylon 20 and the forward casing 104; and a second part formed by second suspension means 42 positioned between the forward end 21 of the pylon 20 and the intermediate casing 105.

The first suspension means in this case comprise two forward link rods 41 arranged in a “V” configuration. The forward link rods 41 are each provided with spherical joints at both ends and point towards the propeller 7 and are inclined with respect to the X-axis and the Z-axis. The forward link rods 41 are fixed to the forward casing 104 at a fastening point 410 located in the vicinity of the Z-axis on an outer periphery of the forward casing 104. At the forward end 21 of the pylon 20, the forward link rods 41 are fixed at fastening points spaced apart in the Y-direction. Hence, in a top view, the forward link rods 41 form a “V”, the vertex of which is oriented forward. The forward link rods 41 forming the first suspension means are configured to take up the thrust delivered by the turbomachine 100, as well as pitching moments.

It should be noted that a “link rod provided with spherical joints at both ends” is understood to mean a link rod comprising a first end and a second end, each of the first and second ends comprising a spherical joint.

The second suspension means in this case comprise two rear link rods 42 which are inclined here in a YZ plane passing through the intermediate casing 105 and with respect to the Z-axis. The rear link rods 42 are mirror-symmetrical with respect to one another. As a variant, the rear link rods 42 may be vertical, that is to say, parallel to the Z-axis. The rear link rods 42 are provided with spherical joints at both ends in this case. They are fixed, on the one hand, to the intermediate casing 105 in the aforementioned YZ plane and, on the other hand, to the forward end 21 of the pylon 20. At the pylon 20, the rear link rods 42 are fixed in the vicinity of the fastening points of the forward link rods 41. The rear link rods 42 allow the engine torque generated by the turbomachine 100 and vertical and/or lateral loads to be taken up.

Moreover, the mounting system 50 comprises rear mounting means 60, in this case comprising two thrust-take-up (load-taking) link rods 60. The link rods 60 are two in number here and extend between the intermediate casing 105, where they are fixed in the YZ plane passing through the intermediate casing 105, and the pylon 20, where they are fixed, without a bell crank, behind the forward end 21 and beneath the pylon 20. The link rods 60 are inclined with respect to the Y-axis and the Z-axis. The link rods 60 are mirror-symmetrical with respect to one another and form, in top view, a “V”, the vertex of which is oriented downstream. The link rods 60 allow thrust and yawing moments to be taken up.

Furthermore, the mounting system 50 comprises one or more flexible connections 9 arranged between a rear casing formed by the turbine casing 106 and/or the exhaust casing 107 and the pylon 20 and extending in a YZ plane. The role of this (these) flexible connection(s) 9 is to limit the impact of inertial loads while limiting the bending moments associated with loads resulting from the engine torque generated by the turbomachine 100, in order to take up vertical and optionally lateral maneuver load factors. The flexibility of these connections 9 is adapted so as to achieve the best compromise between inertial effects and the aerodynamic moments of the turbomachine propeller 100.

Implementation of a mounting system 50 such as that described above makes it possible to distribute loads more effectively within the pylon 20 and thereby limit relative displacements between the turbomachine 100 and the pylon 20, while protecting a rear portion of the turbomachine 100 from bending moments. A solution of this kind also provides the following advantages: taking up torque on the intermediate casing 105 makes it possible to rely on a larger cross section of the pylon 20 which is better suited for transmitting loads without excessive torsion; the inclination of the forward link rods 41 arranged in a “V” configuration makes it possible to bring the point of convergence of the loads closer to the propeller (which makes it possible to reduce the resulting moment from the engine torque loads by reducing the lever arm thereof with respect to a projection onto the longitudinal axis XX of the forward suspensions); replacing a forward pylon section of the prior art (working in bending and torsion) by two forward link rods 41 provided with spherical joints at both ends (therefore working in tension and compression) makes it possible to shorten the pylon 20 (the forward end 21 of which is then aligned with the intermediate casing 105) and consequently to drastically reduce the aerodynamic impact of the OGV (Anglo-Saxon acronym for “Outer Guide Vane”, i.e., secondary flow outlet) and of the wing of the forward mounting means 40 of the turbomachine (YZ load take-up), the forward link rods 41 therefore being buried and inclined in a “V” configuration and not forming a “wall” for the upstream flow, unlike a large pylon section; the forward mounting means 40 between the turbomachine 100 and the pylon 20 are fixed to the pylon at the level of the YZ plane passing through the intermediate casing 105, which facilitates under-wing maintenance (for the engine part, this mounting nevertheless remains close to the OGVs); and the system of forward link rods 41 arranged in a “V” configuration is lighter than the forward pylon section of the prior art that they replace.

Naturally, the invention has been described above by way of example. It is understood that a person skilled in the art is able to produce various alternative embodiments of the invention without departing from the scope of the invention. It is emphasized that all the features, as they emerge to a person skilled in the art from the present description, the drawings and the appended claims, even if they have been described in practice only in relation to certain specific features, whether individually or in any combinations, may be combined with other features or groups of features disclosed herein, provided that this has not been expressly excluded or that technical circumstances do not render such combinations impossible or meaningless.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Moreover, throughout this document including the claims, expressions such as “at least one of”, or “one or more of”, when preceding a list of elements, modify the entire list of elements and do not modify the individual elements of the list.

1. An assembly for an aircraft comprising:
a turbomachine,
a pylon having a forward end and a mounting system for mounting the turbomachine to the pylon, the turbomachine extending along a longitudinal axis oriented along an X-axis oriented in a direction of a flow generated by the turbomachine, of an orthonormal frame of reference comprising a Z-axis oriented towards the pylon,
the turbomachine comprising, along the longitudinal axis, a forward casing, an intermediate casing and a rear casing,
the mounting system comprising forward mounting means including first suspension means for suspending the turbomachine from the pylon fixed at a level of the forward casing of the turbomachine and rear mounting means for mounting the turbomachine to the pylon fixed at the level of the intermediate casing of the turbomachine,
wherein the forward mounting means comprise second suspension means for suspending the turbomachine from the pylon fixed at the level of the intermediate casing, the first and second suspension means being fixed to the pylon in the same plane perpendicular to the longitudinal axis, and
wherein the first suspension means comprise a first forward link rod and a second forward link rod.

2. The assembly according to claim 1, wherein the plane perpendicular to the longitudinal axis is a plane passing through the intermediate casing.

3. The assembly according to claim 1, wherein the first and second suspension means are fixed to the pylon at the forward end of the pylon.

4. The assembly according to claim 1, wherein the first and second forward link rods each comprise a first end and a second end, each of the first ends and second ends comprising a spherical joint.

5. The assembly according to claim 1, wherein the first and second forward link rods are arranged in a “V” configuration, a vertex of the “V” being oriented forward.

6. The assembly according to claim 1, wherein the second suspension means comprise a first rear link rod and a second rear link rod extending in a YZ plane perpendicular to the longitudinal axis.

7. The assembly according to claim 1, wherein the rear mounting means comprise two load-take-up link rods arranged in a “V” configuration, a vertex of the “V” being oriented rearward and fixed to the pylon.

8. The assembly according to claim 1, wherein the mounting system comprises a flexible connection positioned between the rear casing, formed by at least one of a turbine casing or an exhaust casing, and the pylon and extending in a YZ plane perpendicular to the longitudinal axis.

9. An aircraft comprising an assembly according to claim 1.

10. An assembly for an aircraft comprising:
a turbomachine,
a pylon having a forward end and a mounting system for mounting the turbomachine to the pylon, the turbomachine extending along a longitudinal axis oriented along an X-axis oriented in a direction of a flow generated by the turbomachine, of an orthonormal frame of reference comprising a Z-axis oriented towards the pylon, the turbomachine comprising, along the longitudinal axis, a forward casing, an intermediate casing and a rear casing,
the mounting system comprising forward mounting means including first suspension means for suspending the turbomachine from the pylon fixed at a level of the forward casing of the turbomachine and rear mounting means for mounting the turbomachine to the pylon fixed at the level of the intermediate casing of the turbomachine,
wherein the forward mounting means comprise second suspension means for suspending the turbomachine from the pylon fixed at the level of the intermediate casing, the first and second suspension means being fixed to the pylon in the same plane perpendicular to the longitudinal axis, and
wherein the second suspension means comprise a first rear link rod and a second rear link rod extending in a YZ plane perpendicular to the longitudinal axis.

11. The assembly according to claim 10, wherein the plane perpendicular to the longitudinal axis is a plane passing through the intermediate casing.

12. The assembly according to claim 10, wherein the first and second suspension means are fixed to the pylon at the forward end of the pylon.

13. The assembly according to claim 10, wherein the first suspension means comprise a first forward link rod and a second forward link rod.

14. The assembly according to claim 13, wherein the first and second forward link rods each comprise a first end and a second end, each of the first and second ends comprising a spherical joint.

15. The assembly according to claim 13, wherein the first and second forward link rods are arranged in a “V” configuration, a vertex of the “V” being oriented forward.

16. The assembly according to claim 10, wherein the rear mounting means comprise two load-taking link rods arranged in a “V” configuration, a vertex of the “V” being oriented rearward and fixed to the pylon.

17. The assembly according to claim 10, wherein the mounting system comprises a flexible connection positioned between the rear casing, formed by at least one of a turbine casing or an exhaust casing, and the pylon and extending in a YZ plane perpendicular to the longitudinal axis.
